(19) United States
(12) Patent Application Publication
(10) Pub. No.: US 2026/0074765 A1
(43) Pub. Date: Mar. 12, 2026

(54) METHOD AND APPARATUS FOR BEAM MEASUREMENT AND RESULT REPORTING FOR ARTIFICIAL INTELLIGENCE AND/OR MACHINE LEARNING MODEL INFERENCE

(71) Applicant: KT CORPORATION, Gyeonggi-do (KR)

(72) Inventors: Eun-Jong Lee, Gyeonggi-do (KR); Kyujin Park, Gyeonggi-do (KR)

(73) Assignee: KT CORPORATION, Gyeonggi-do (KR)

(21) Appl. No.: 19/394,812

(22) Filed: Nov. 19, 2025

Related U.S. Application Data
(63) Continuation of application No. PCT/KR2024/006619, filed on May 16, 2024.

(30) Foreign Application Priority Data
May 19, 2023 (KR) 10-2023-0065183
May 10, 2024 (KR) 10-2024-0062142

(51) Int. Cl. H04B 7/06; H04L 5/00; H04W 24/10

(52) U.S. Cl. CPC H04B 7/0626; H04L 5/0048; H04W 24/10

(57) ABSTRACT

Provided are a method and apparatus for beam measurement and result reporting for artificial intelligence and/or machine learning model inference. The method may include receiving a single CSI configuration message including information on at least two CSI (channel state information)-RS (reference signal) resource sets from a base station, measuring at least one CSI-RS corresponding to a first CSI-RS resource set among the at least two CSI-RS resource sets based on the received single CSI configuration message, and transmitting a report of a measurement result for the at least one CSI-RS, wherein the report of the measurement result for the at least one CSI-RS is based on an identity (ID) of a second CSI-RS resource set among the at least two CSI-RS resource sets.

### TECHNICAL FIELD

The present disclosure relates to wireless communications in 5G NR, 5G-Advanced, and 6G.

### BACKGROUND ART

As more communication devices require greater data traffic, the necessity for a next generation 5G system, enhanced over legacy LTE systems, is emerging. In the next generation 5G system, scenarios can be classified into Enhanced Mobile BroadBand (eMBB), Ultra-reliability and low-latency communication (URLLC), Massive Machine-Type Communications (mMTC), and the like.

Here, eMBB corresponds to a next generation mobile communication scenario having characteristics such as high spectrum efficiency, high user experienced data rate, high peak data rate, and the like. URLLC corresponds to a next generation mobile communication scenario having characteristics such as ultra-reliability, ultra-low latency, ultra-high availability, and the like (e.g., V2X, Emergency Service, Remote Control). mMTC corresponds to a next generation mobile communication scenario having characteristics such as low cost, low energy, short packet, and massive connectivity (e.g., IoT).

### DISCLOSURE OF INVENTION

### Technical Problem

The disclosure of the present specification is to provide a method and apparatus for indicating an association between beams to be used as an input value (Set B) and beams to be used as an output value (Set A) of an AI/ML model for a terminal that performs beam management based on AI/ML in a wireless communication system, and to enable the terminal receiving a corresponding configuration to perform beam measurement and result reporting.

### Solution to Problem

In accordance with an embodiment, a method of a terminal may be provided for operation in a wireless communication system. The method of the terminal may include receiving a single CSI configuration message from a base station, the message including information on at least two CSI (channel state information)-RS (reference signal) resource sets, measuring at least one CSI-RS corresponding to a first CSI-RS resource set among the at least two CSI-RS resource sets based on the received single CSI configuration message, and transmitting a report of a measurement result for the at least one CSI-RS, wherein the report of the measurement result for the at least one CSI-RS is based on an identity (ID) of a second CSI-RS resource set among the at least two CSI-RS resource sets.

In accordance with another embodiment, a method of a base station may be provided for operation in a wireless communication system. The method of the base station may include transmitting a single CSI configuration message to a terminal, the message including information on at least two CSI (channel state information)-RS (reference signal) resource sets, based on the transmitted single CSI configuration message, transmitting at least one CSI-RS corresponding to a first CSI-RS resource set among the at least two CSI-RS resource sets to the terminal, and receiving a report of a measurement result for the at least one CSI-RS from the terminal, wherein the report of the measurement result for the at least one CSI-RS is based on an identity (ID) of a second CSI-RS resource set among the at least two CSI-RS resource sets.

In accordance with further another embodiment, a communication apparatus may be provided for operation in a wireless communication system. The apparatus may include: at least one processor; and at least one memory configured to store instructions and be operably electrically connectable to the at least one processor, wherein operations performed based on the instructions executed by the at least one processor include: receiving a single CSI configuration message from a base station, the message including information on at least two CSI (channel state information)-RS (reference signal) resource sets, thereafter, based on the received single CSI configuration message, measuring at least one CSI-RS corresponding to a first CSI-RS resource set among the at least two CSI-RS resource sets, and transmitting a report of a measurement result for the at least one CSI-RS, wherein the report of the measurement result for the at least one CSI-RS is based on an identity (ID) of a second CSI-RS resource set among the at least two CSI-RS resource sets.

In accordance with still another embodiment, a base station may be provided for operation in a wireless communication system. The base station may include: at least one processor; and at least one memory configured to store instructions and be operably electrically connectable to the at least one processor, wherein operations performed based on the instructions executed by the at least one processor include: transmitting a single CSI configuration message to a terminal, the message including information on at least two CSI (channel state information)-RS (reference signal) resource sets, subsequently, based on the transmitted single CSI configuration message, transmitting at least one CSI-RS corresponding to a first CSI-RS resource set among the at least two CSI-RS resource sets to the terminal, and receiving a report of a measurement result for the at least one CSI-RS from the terminal, wherein the report of the measurement result for the at least one CSI-RS is based on an identity (ID) of a second CSI-RS resource set among the at least two CSI-RS resource sets.

The first CSI-RS resource set may be a subset of the second CSI-RS resource set, and the identity may be a CSI resource indicator (CRI).

Meanwhile, the measurement result for the at least one CSI-RS may be based on a strength of the at least one CSI-RS.

Preferably, the at least two CSI-RS resource sets are at least two non-zero power (NZP) CSI-RS resource sets whose resource type is periodic or semi-persistent.

Based on the identity, the second CSI-RS resource set may be used for prediction inferred by an AI/ML (artificial intelligence/machine learning) model.

### Advantageous Effects of Invention

According to the embodiments of the disclosure, when performing a beam management technique based on AI/ML, a network (or base station)/terminal performs an operation of transmitting (or sweeping) and measuring only a limited number of beams, thereby reducing CSI-RS overhead allocated in the system and minimizing the beam measurement burden on the terminal, which results in improved overall system performance.

### BRIEF DESCRIPTION OF DRAWINGS

FIG. 1 illustrates a wireless communication system.

FIG. 2 illustrates a structure of a radio frame used in NR.

FIGS. 3A to 3C illustrate exemplary architectures for a wireless communication service.

FIG. 4 illustrates a slot structure of a new radio (NR) frame.

FIG. 5 shows an example of a subframe type in NR.

FIG. 6 illustrates a structure of a self-contained slot.

FIG. 7 illustrates an example of initial beam measurement and selection in NR.

FIG. 8 illustrates an example of an initial access procedure between a terminal and a base station in NR.

FIG. 9 illustrates an example of candidate beam configuration in NR.

FIGS. 10A to 10C illustrate three procedures for beam management in NR.

FIGS. 11A to 11C illustrate examples of beam reporting procedures in NR.

FIGS. 12A and 12B illustrate an example of beam measurement and spatial domain beam prediction using AI/ML.

FIG. 13 illustrates an example of temporal domain beam prediction using AI/ML.

FIG. 14 illustrates an operation method of a terminal according to an embodiment of the disclosure.

FIG. 15 is an example illustrating the association between CSI resource sets according to an embodiment of the disclosure.

FIG. 16 illustrates an example of beam mapping for two associated CSI-RS resource sets according to an embodiment of the disclosure.

FIG. 17 illustrates a procedure between a terminal and a base station according to an embodiment of the disclosure.

FIG. 18 illustrates a procedure between a terminal and a base station according to another embodiment of the disclosure.

FIG. 19 illustrates an operation method of a terminal according to another embodiment of the disclosure.

FIG. 20 illustrates an operation method of a base station according to an embodiment of the disclosure.

FIG. 21 shows apparatuses according to an embodiment of the disclosure.

FIG. 22 is a block diagram showing a configuration of a terminal according to an embodiment of the disclosure.

FIG. 23 is a configuration block diagram of a processor in which the disclosure is implemented.

FIG. 24 is a detailed block diagram of a transceiver of a first apparatus shown in FIG. 21 or a transceiving unit of an apparatus shown in FIG. 22.

### MODE FOR THE INVENTION

The technical terms used herein are intended to merely describe specific embodiments and should not be construed as limiting the disclosure. Further, the technical terms used herein should be, unless defined otherwise, interpreted as having meanings generally understood by those skilled in the art but not too broadly or too narrowly. Additionally, the technical terms used herein, which are determined not to exactly represent the spirit of the disclosure, should be replaced by or understood by such technical terms as being able to be exactly understood by those skilled in the art. Finally, the general terms used herein should be interpreted in the context as defined in the dictionary, but not in an excessively narrowed manner.

The expression of the singular form in the disclosure includes the meaning of the plural form unless the meaning of the singular form is definitely different from that of the plural form in the context. In the following description, the term ‘include’ or ‘have’ may represent the existence of a feature, a number, a step, an operation, a component, a part or the combination thereof described in the disclosure and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without departing from the scope of the disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the disclosure will be described in greater detail with reference to the accompanying drawings. In describing the disclosure, for ease of understanding, the same reference numerals are used to denote the same components throughout the drawings, and repetitive description on the same components will be omitted. Detailed description on well-known arts that are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to include its modifications, replacements or equivalents in addition to what is shown in the drawings.

In the disclosure, “A or B” may mean “only A”, “only B”, or “both A and B”. In other words, “A or B” in the disclosure may be interpreted as “A and/or B”. For example, “A, B or C” in the disclosure may mean “only A”, “only B”, “only C”, or “any combination of A, B and C”.

In the disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the disclosure, “at least one of A and B” may mean “only A”, “only B” or “both A and B”. In addition, the expression “at least one of A or B” or “at least one of A and/or B” in the disclosure may be interpreted as the same as “at least one of A and B”.

In addition, in the disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the disclosure may mean “for example”. In detail, when it is shown as “control information (PDCCH)”, “physical downlink control channel (PDCCH)” may be proposed as an example of “control information”. In other words, “control information” in the disclosure is not limited to “PDCCH”, and “PDDCH” may be proposed as an example of “control information”. In addition, even when shown as “control information (i.e., PDCCH)”, “PDCCH” may be proposed as an example of “control information”.

The technical features described individually in one drawing in this specification may be implemented separately or at the same time.

In the accompanying drawings, user equipment (UE) is illustrated by way of example, but the illustrated UE may be also referred to as a terminal, mobile equipment (ME), or the like. In addition, the UE may be a portable device such as a laptop computer, a mobile phone, a PDA, a smart phone, a multimedia device, or the like, or may be a non-portable device such as a PC or a vehicle-mounted device.

Hereinafter, the UE is used as an example of a device capable of wireless communication (e.g., a wireless communication device, a wireless device, or a wireless apparatus). The operation performed by the UE may be performed by any device capable of wireless communication. A device capable of wireless communication may also be referred to as a radio communication device, a wireless device, or a wireless apparatus.

A base station, a term used below, generally refers to a fixed station that communicates with a wireless device, and may be used to cover the meanings of terms including an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), a repeater (relay), and so on.

Although embodiments of the disclosure will be described based on an LTE system, an LTE-advanced (LTE-A) system, and an NR system, such embodiments may be applied to any communication system corresponding to the aforementioned definition.

### <Wireless Communication System>

With the success of long term evolution (LTE)/LTE-A (LTE-Advanced) for the 4th generation mobile communication, the next generation, i.e., 5^{th} generation (so called 5G) mobile communication has been commercialized and the follow-up studies are also ongoing.

The 5^{th} generation mobile communications defined by the International Telecommunication Union (ITU) refers to communication providing a data transmission rate of up to 20 Gbps and a minimum actual transmission rate of at least 100 Mbps anywhere. The official name of the 5^{th} generation mobile telecommunications is ‘IMT-2020.’

The ITU proposes three usage scenarios, namely, enhanced Mobile Broadband (eMBB), massive Machine Type Communication (mMTC) and Ultra Reliable and Low Latency Communications (URLLC).

The URLLC relates to a usage scenario that requires high reliability and low latency. For example, services such as autonomous driving, factory automation, augmented reality require high reliability and low latency (e.g., a delay time of less than 1 ms). The delay time of current 4G (LTE) is statistically 21 to 43 ms (best 10%) and 33 to 75 ms (median). This is insufficient to support a service requiring a delay time of 1 ms or less. Next, the eMBB usage scenario relates to a usage scenario requiring mobile ultra-wideband.

That is, the 5G mobile communication system supports higher capacity than the current 4G LTE, and may increase the density of mobile broadband users and support device to device (D2D), high stability, and machine type communication (MTC). The 5G research and development also aims at a lower latency time and reduce battery consumption compared to a 4G mobile communication system to better implement the Internet of things. A new radio access technology (new RAT or NR) may be proposed for such 5G mobile communication.

An NR frequency band is defined as two types of frequency ranges: FR1 and FR2. The numerical value in each frequency range may vary, and the frequency ranges of the two types FR1 and FR2 may for example be shown in Table 1 below. For convenience of description, FR1 among the frequency ranges used in the NR system may refer to a Sub-6 GHz range, and FR2 may refer to an above-6 GHz range, which may be called millimeter waves (mmWs).

TABLE 1

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

The numerical values in the frequency range may vary in the NR system. For example, FR1 may range from 410 MHz to 7125 MHz as listed in [Table 1]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, such as, vehicle communication (e.g., autonomous driving). Meanwhile, the 3GPP communication standards define downlink (DL) physical channels corresponding to resource elements (REs) carrying information originated from a higher layer, and DL physical signals which are used in the physical layer and correspond to REs that do not carry information originated from a higher layer. For example, physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as DL physical channels, and reference signals (RSs) and synchronization signals (SSs) are defined as DL physical signals. An reference signal (RS), also called a pilot signal, is a signal with a predefined special waveform known to both a gNode B (gNB) and a UE. For example, cell specific RS, UE-specific RS (UE-RS), positioning RS (PRS), and channel state information RS (CSI-RS) are defined as DL RSs. The 3GPP LTE/LTE-A standards define uplink (UL) physical channels corresponding to REs carrying information originated from a higher layer, and UL physical signals which are used in the physical layer and correspond to REs which do not carry information originated from a higher layer. For example, physical uplink shared channel (PUSCH), physical uplink control channel (PUCCH), and physical random access channel (PRACH) are defined as UL physical channels, and a demodulation reference signal (DMRS) for a UL control/data signal, and a sounding reference signal (SRS) used for UL channel measurement are defined as UL physical signals.

In the disclosure, the PDCCH/PCFICH/PHICH/PDSCH refers to a set of time-frequency resources or a set of REs, which carry downlink control information (DCI)/a control format indicator (CFI)/a DL acknowledgement/negative acknowledgement (ACK/NACK)/DL data. Further, the PUCCH/PUSCH/PRACH refers to a set of time-frequency resources or a set of REs, which carry UL control information (UCI)/UL data/a random access signal.

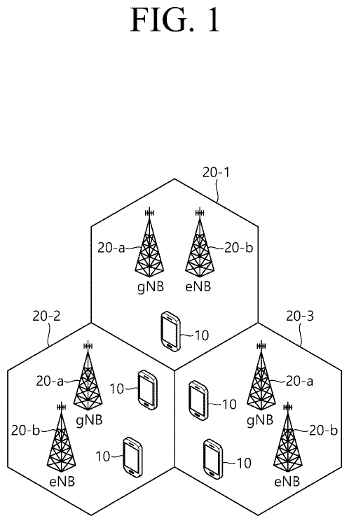

FIG. 1 illustrates a wireless communication system.

Referring to FIG. 1, the wireless communication system includes at least one base station (BS). The BS includes a gNodeB (or gNB) 20a and an eNodeB (or eNB) 20b. The gNB 20a supports the 5G mobile communication. The eNB 20b supports the 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, other cells adjacent to the serving cell exist. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, the transmitter may be a part of the base station 20, and the receiver may be a part of the UE 10. In the uplink, the transmitter may be a part of the UE 10, and the receiver may be a part of the base station 20.

Meanwhile, a wireless communication system may be largely divided into a frequency division duplex (FDD) scheme and a time division duplex (TDD) scheme. According to the FDD scheme, uplink transmission and downlink transmission are performed while occupying different frequency bands. According to the TDD scheme, uplink transmission and downlink transmission are performed at different times while occupying the same frequency band. The channel response of the TDD scheme is substantially reciprocal. This means that the downlink channel response and the uplink channel response are almost the same in a given frequency domain. Accordingly, in the TDD-based radio communication system, there is an advantage that the downlink channel response can be obtained from the uplink channel response. In the TDD scheme, since uplink transmission and downlink transmission are time-divided in the entire frequency band, downlink transmission by the base station and uplink transmission by the UE cannot be performed simultaneously. In a TDD system in which uplink transmission and downlink transmission are divided in subframe units, uplink transmission and downlink transmission are performed in different subframes.

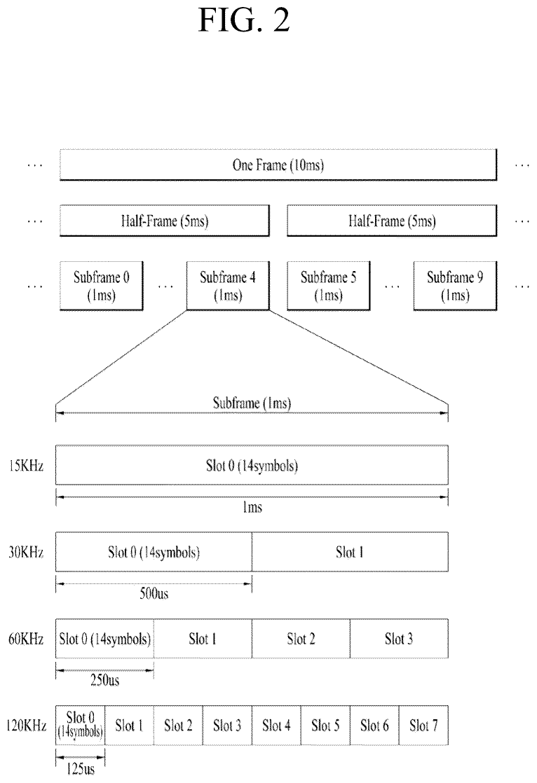

FIG. 2 illustrates a structure of a radio frame used in NR.

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on an SCS. Each slot includes 12 or 14 OFDM (A) symbols according to a CP. When a normal CP is used, each slot includes 14 OFDM symbols. When an extended CP is used, each slot includes 12 OFDM symbols. A symbol may include an OFDM symbol (CP-OFDM symbol) and an SC-FDMA symbol (or DFT-s-OFDM symbol).

### <Support of Various Numerologies>

With the development of wireless communication technology, multiple numerologies may be available to UEs in the NR system. For example, in the case where a subcarrier spacing (SCS) is 15 kHz, a wide area of the typical cellular bands is supported. In the case where an SCS is 30 kHz/60 kHz, a dense-urban, lower latency, wider carrier bandwidth is supported. In the case where the SCS is 60 kHz or higher, a bandwidth that is greater than 24.25 GHz is supported in order to overcome phase noise.

The numerologies may be defined by a cyclic prefix (CP) length and a subcarrier spacing (SCS). A single cell can provide a plurality of numerologies to UEs. When an index of a numerology is represented by u, a subcarrier spacing and a corresponding CP length may be expressed as shown in the following table.

TABLE 2

| μ | Δf = 2^{μ} · 15 [kHz] | CP |
|---|---|---|
| 0 | 15 | normal |
| 1 | 30 | normal |
| 2 | 60 | normal, extended |
| 3 | 120 | normal |
| 4 | 240 | normal |
| 5 | 480 | normal |
| 6 | 960 | normal |

In the case of a normal CP, when an index of a numerology is expressed by μ, the number of OLDM symbols per slot N^{slot}_{symb}, the number of slots per frame N^{frame,μ}ₛₗₒₜ, and the number of slots per subframe N^{subframe,μ}ₛₗₒₜ slot are expressed as shown in the following table.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

In the case of an extended CP, when an index of a numerology is represented by μ, the number of OLDM symbols per slot N^{slot}_{symb}, the number of slots per frame N^{frame,μ}ₛₗₒₜ, and the number of slots per subframe N^{subframe,μ}ₛₗₒₜ slot are expressed as shown in the following table.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz (u = 2) | 12 | 40 | 4 |

In the NR system, OFDM (A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

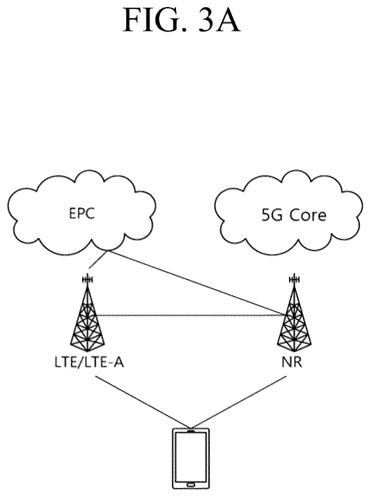

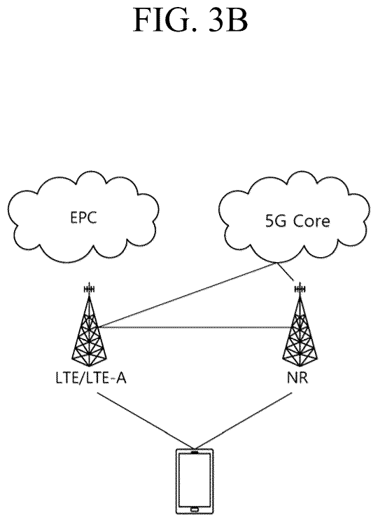

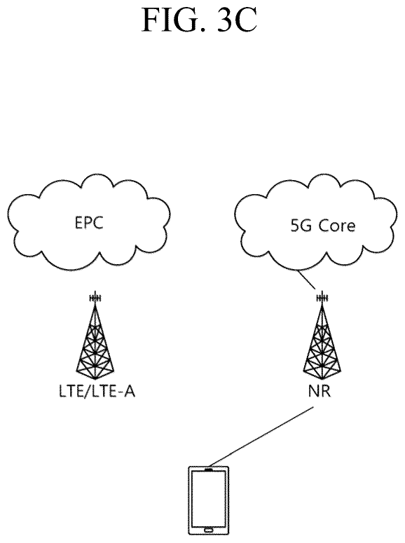

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 3B, the LTE/LTE-A cell is connected with a core network for 5th generation mobile communication, that is, a 5G core network, unlike the example in FIG. 3A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the above new radio access technology (NR), using a downlink subframe for reception from a base station and using an uplink subframe for transmission to the base station may be considered. This method may be applied to both paired and not-paired spectrums. A pair of spectrums indicates including two subcarriers for downlink and uplink operations. For example, one subcarrier in one pair of spectrums may include a pair of a downlink band and an uplink band.

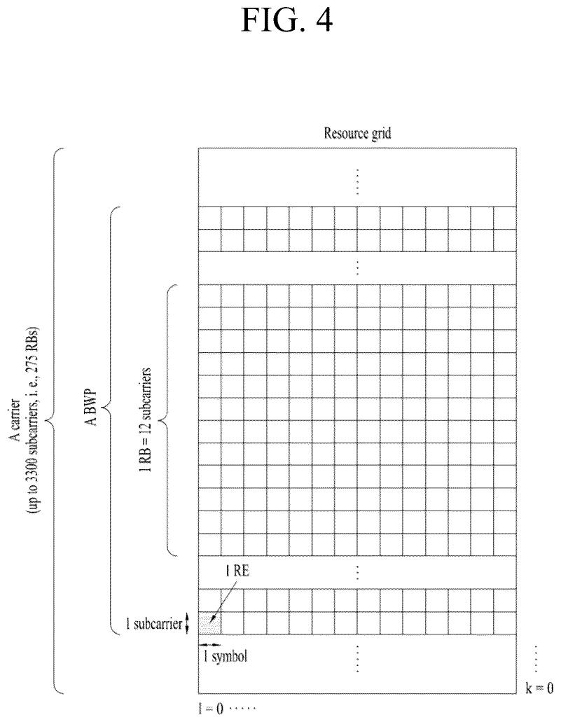

FIG. 4 illustrates a slot structure of an NR frame.

A slot includes a plurality of symbols in the time domain. For example, in the case of the normal CP, one slot includes seven symbols. On the other hand, in the case of an extended CP, one slot includes six symbols. A carrier includes a plurality of subcarriers in the frequency domain. A resource block (RB) is defined as consecutive subcarriers (e.g., 12 consecutive subcarriers) in the frequency domain. A bandwidth part (BWP) is defined as a plurality of consecutive physical (P) RBs in the frequency domain and may correspond to one numerology (e.g., SCS, CP length, etc.). A UE may be configured with up to N (e.g., five) BWPs in both the downlink and the uplink. The downlink or uplink transmission is performed through an activated BWP, and only one BWP among the BWPs configured for the UE may be activated at a given time. In the resource grid, each element is referred to as a resource element (RE), and one complex symbol may be mapped thereto.

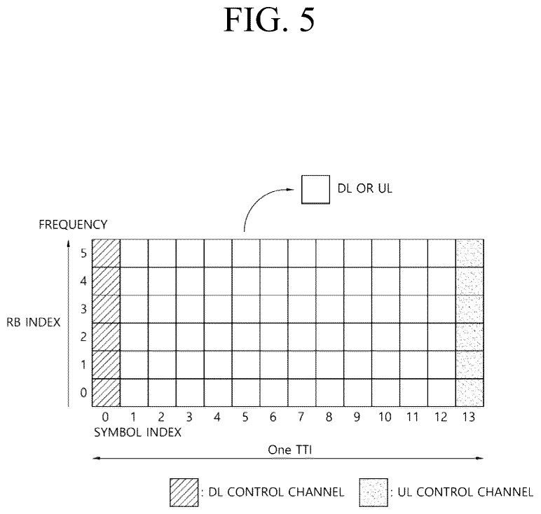

FIG. 5 shows an example of a subframe type in NR.

Referring to FIG. 5, a TTI (Transmission Time Interval) may be called a subframe or a slot for NR (or new RAT). The subframe (or slot) shown in FIG. 5 can be used in a TDD system of NR (or new RAT) to minimize data transmission delay. As shown in FIG. 5, a subframe (or slot) includes 14 symbols. The symbol at the head of the subframe (or slot) can be used for a DL control channel and the symbol at the end of the subframe (or slot) can be used for a UL control channel. The remaining symbols can be used for DL data transmission or UL data transmission. According to this subframe (or slot) structure, downlink transmission and uplink transmission can be sequentially performed in one subframe (or slot). Accordingly, downlink data can be received in a subframe (or slot) and uplink ACK/NACL may be transmitted in the subframe (or slot).

Such a subframe (or slot) structure may be called a self-contained subframe (or slot).

Specifically, the first N symbols (hereinafter referred to as the DL control region) in a slot may be used to transmit a DL control channel, and the last M symbols (hereinafter referred to as the UL control region) in the slot may be used to transmit a UL control channel. N and M are integers greater than 0. A resource region between the DL control region and the UL control region (hereinafter referred to as a data region) may be used for DL data transmission or UL data transmission. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

When this subframe (or slot) structure is used, a time taken to retransmit data that has failed in reception may be reduced to minimize final data transmission latency. In such a self-contained subframe (or slot) structure, a time gap may be required in a process of transition from a transmission mode to a reception mode or from the reception mode to the transmission mode. To this end, some OFDM symbols when DL switches to UL in the subframe structure can be configured to a guard period (GP).

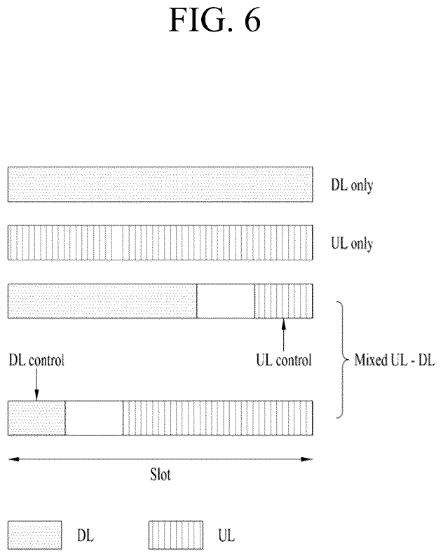

FIG. 6 illustrates a structure of a self-contained slot.

In the NR system, the frame has a self-contained structure, in which all of a DL control channel, DL or UL data channel, UL control channel, and other elements are included in one slot. For example, the first N symbols (hereinafter referred to as a DL control region) in a slot may be used for transmitting a DL control channel, and the last M symbols (hereinafter referred to as an UL control region) in the slot may be used for transmitting an UL control channel. N and M are integers greater than 0. A resource region between the DL control region and the UL control region (hereinafter referred to as a data region) may be used for DL data transmission or UL data transmission. For example, the following configurations may be taken into account. The durations are listed in temporal order.
1. DL only configuration
2. UL only configuration
3. Mixed UL-DL configuration
   DL region+Guard Period (GP)+UL control region
   DL control region+GP+UL region
DL region: (i) DL data region, (ii) DL control region+DL data region
UL region: (i) UL data region, (ii) UL data region+UL control region

A PDCCH may be transmitted in the DL control region, and a PDSCH may be transmitted in the DL data region. A PUCCH may be transmitted in the UL control region, and a PUSCH may be transmitted in the UL data region. In the PDCCH, Downlink Control Information (DCI), for example, DL data scheduling information or UL data scheduling data may be transmitted. In the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A GP provides a time gap during a process where a gNB and a UE transition from the transmission mode to the reception mode or a process where the gNB and UE transition from the reception mode to the transmission mode. Part of symbols belonging to the occasion in which the mode is changed from DL to UL within a subframe may be configured as the GP.

### <Beam Management in NR>

The existing 3GPP NR beam management procedure can be divided into an initial access stage and a connection establishment stage. A terminal performing an initial access procedure configures it's initial transmit/receive (Tx/Rx) beam through a random access channel (RACH) procedure.

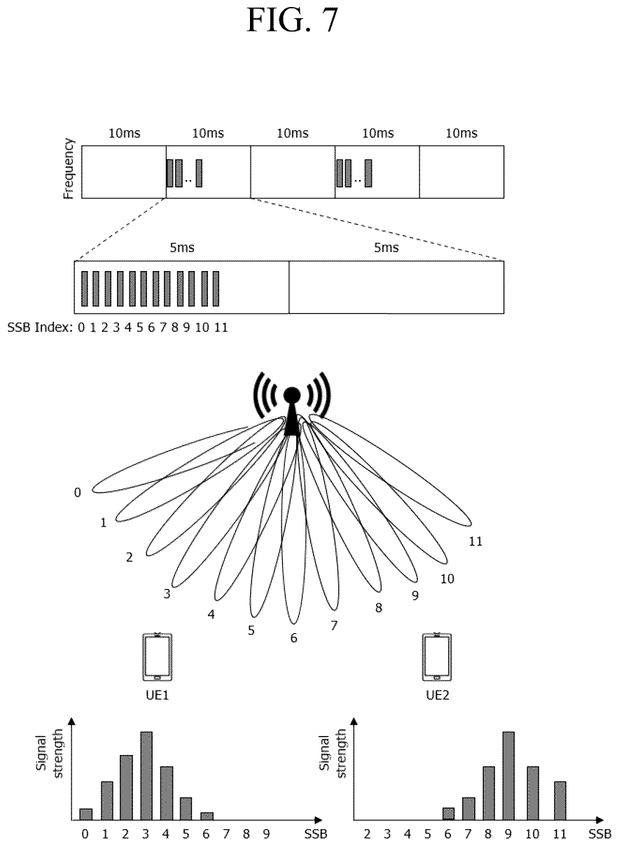

FIG. 7 illustrates an example of initial beam measurement and selection in NR.

Referring to FIG. 7, in order to provide a base station transmit beam (gNB Tx beam) configuration to terminals without a cell connection (UE1/UE2), the base station periodically and repeatedly transmits synchronization signal blocks (SSBs), each mapped to beams in different directions. Within 5 ms, a set of SSBs may be transmitted, and the SSB transmission may be repeated with a 20 ms period. Specifically, the default value for initial cell selection may be 20 ms.

A terminal selects a qualified SSB (e.g., suitable SSB) based on signal measurements of the periodically transmitted SSBs and may inform the base station of the selected Tx beam by transmitting a physical random access channel (PRACH) preamble mapped to the corresponding SSB. For example, based on signal strength measurement, terminals at different locations, i.e., UE1 selects an SSB with SSB index 3, and UE2 selects an SSB with SSB index 9, and UE1 and UE2 may each transmit a corresponding PRACH preamble for the selected SSB. Here, it is assumed that each SSB is beamformed in a specific direction.

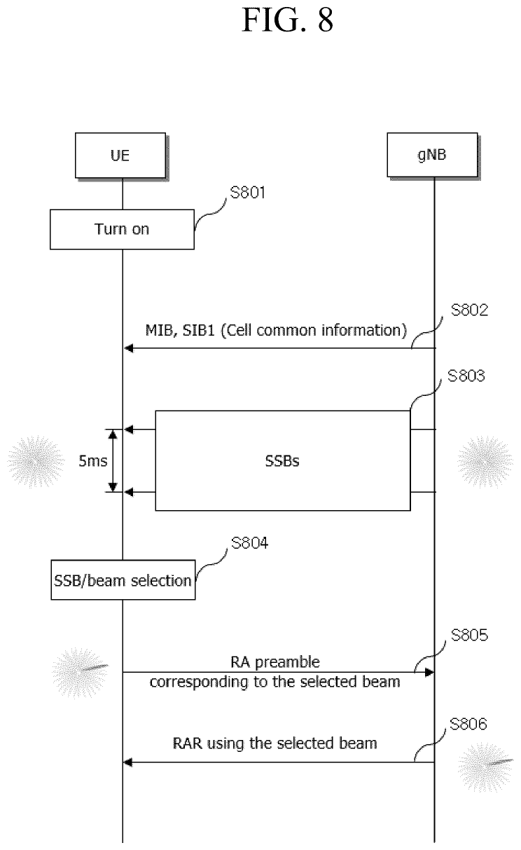

FIG. 8 illustrates an example of an initial access procedure between a terminal and a base station in NR.

Referring to FIG. 8, after the terminal (UE) is powered on (S801), the UE receives cell-related parameter information (e.g., PRACH information corresponding to each SSB) required in the initial access stage through a system information message transmitted by the base station (gNB) (S802). The system information message includes a master information block (MIB) and a system information block 1 (SIB1) which contains cell common information.

After the terminal acquires the system information message, the terminal receives SSBs periodically transmitted from the base station S803. Then, the terminal measures the reference signal received power (RSRP) for the received SSBs. Among the measured RSRPs for N SSBs, that is, beams, the terminal selects one SSB (beam) having the highest/qualified value S804.

Thereafter, the terminal transmits a random access (RA) preamble belonging to a PRACH resource corresponding to the selected SSB (beam) to the base station S805. Through this, the terminal may inform the base station of the selected initial beam information.

The base station receives the RA preamble belonging to the PRACH resource corresponding to the selected SSB (beam) from the terminal and, in response, transmits a random access response (RAR) to the terminal using the selected SSB (beam) S806.

Meanwhile, because a base station does not know the location/beam information of a terminal that has just entered a cell, i.e., a terminal performing a contention based random access (CBRA) procedure, may configure up to 64 beams as cell common beams for a disconnected terminal, and the terminal performs an operation of sequentially measuring all beams to find an optimal beam for its location. As the number of beams in a cell increases, this not only causes delay in beam selection and cell connection, but may also increase power consumption at the terminal because the terminal must measure a large number of beams.

To address the foregoing problem, the base station may map a wide beam to an SSB to identify an approximate location/beam direction of an initially connecting terminal and, after the terminal connects to the cell. The base station may configure a narrow beam through a beam refinement operation. However, although a narrow beam, while providing a high data rate to the terminal, is sensitive to the terminal's movement or environmental changes, and thus disconnection may easily occur. To address this, the base station, by allocating CSI resource (CSI-RS/SSB) to which candidate beams are mapped, to the terminal in a UE-specific manner, has the terminal continuously measure the surrounding beam strength and report the measurement results to the base station. This may be configured by the base station through a CSI resource configuration and a CSI report configuration.

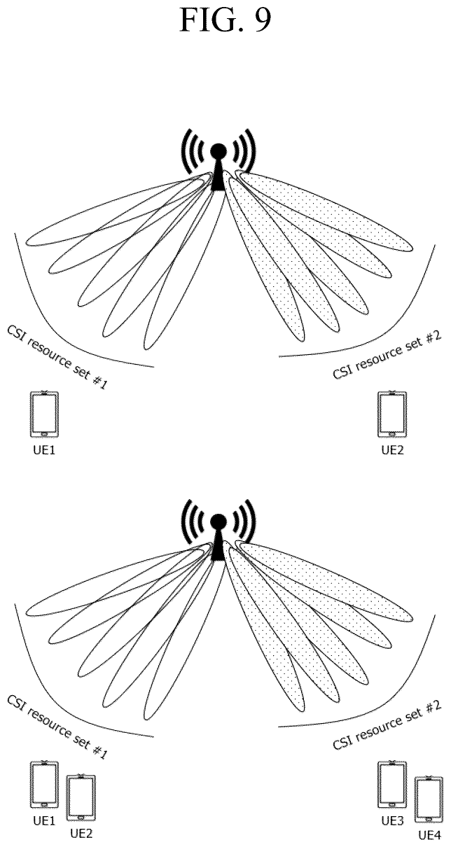

FIG. 9 illustrates an example of candidate beam configuration in NR.

A terminal that has received a beam reporting configuration performs reporting based on the base station's configuration by measuring a reference signal (RS) allocated to it. This conforms to the CSI framework defined in 3GPP. However, this UE-specific CSI configuration method has a drawback in that as the number of terminals in a cell increases, the RS resources allocated per terminal increase rapidly. To alleviate this resource overhead problem, the base station may choose a method of allocating the same candidate beam, that is, the same CSI resource, to terminals in similar locations, as shown in FIG. 9. This may be called a UE group-specific CSI resource configuration. However, when terminals with different mobilities share the same resource, an issue arises in which a new candidate beam resource must be allocated to a terminal that moves out of the corresponding resource area. When a minimum number of candidate beams are allocated to reduce resource overhead for terminals with high/medium mobility, the terminal will experience frequent RRC reconfigurations, and reconfiguring candidate beams through RRC causes a relatively large delay, which may be a cause of beam disconnection. To alleviate this issue, the base station may operate the candidate beams by appropriately increasing the number of beams belonging to a CSI resource set. However, from the terminal's perspective, this causes a trade-off, as the burden of measurement increases due to the increased number of beams.

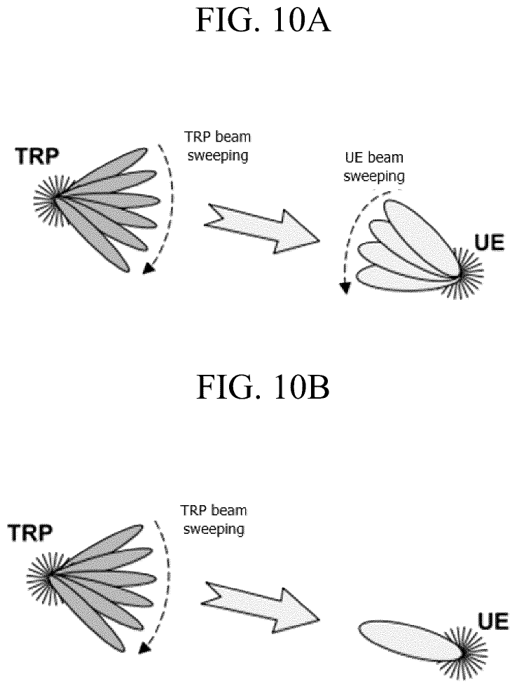

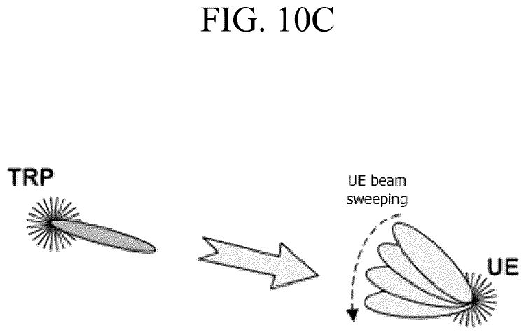

FIGS. 10A to 10C illustrate three procedures for beam management in NR.

Beam management in NR may be defined as being divided into three procedures from the perspective of the physical-layer procedures. FIG. 10A illustrates procedure 1 (P1), FIG. 10B shows procedure 2 (P2), and FIG. 10C shows procedure 3 (P3), respectively. P1 is an operation that finds a transmit/receive beam pair (Tx/Rx beam pair) by performing TRP (transmission reception point) beam sweeping and UE beam sweeping simultaneously, similar to the beam configuration method for a terminal performing the previously described initial access procedure. A terminal that has entered connected mode recognizes that the beams configured through a candidate beam (i.e., CSI resource set) configuration from the base station will be swept, and first performs a signal strength measurement for a TRP beam. When the terminal's TRP beam is selected through P2, the base station then transmits the selected single beam repeatedly through P3. The terminal may select a UE beam while performing UE beam sweeping. Which beam the UE selects in this operation may be left to the terminal implementation. The aforementioned operation may be applied to both downlink (DL) and uplink (UL).

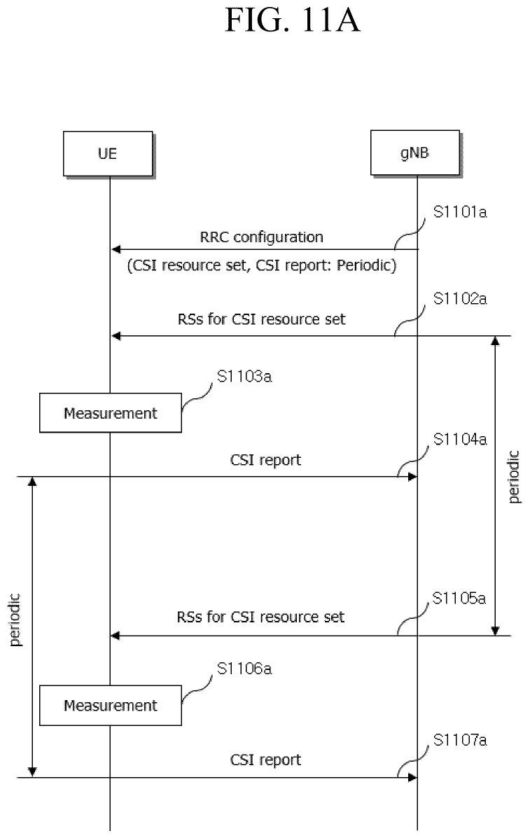

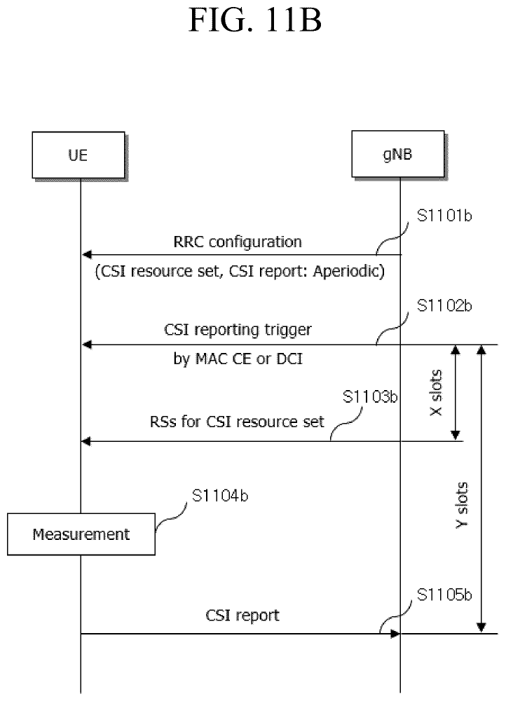

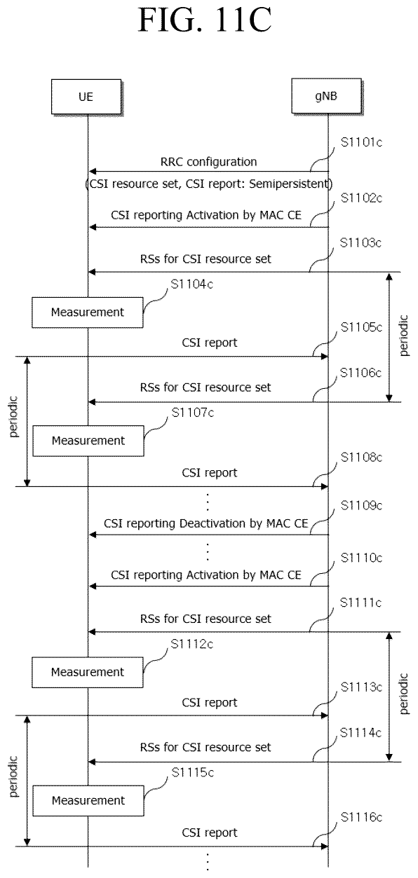

FIGS. 11A to 11C illustrate examples of beam reporting procedures in NR.

For beam sweeping, when a candidate beam is configured—, i.e., when a CSI resource set is configured—the base station provides reference signal (RS) resource information to the terminal, and beam information is implicitly indicated by being mapped to the RS resources, That is, instead of explicitly informing the terminal of the actual beam index, the base station allows the terminal to recognize the beam information mapped by the base station through index information implicitly mapped as RS information using a resource indicator (RI). This is configured using the 3GPP CSI framework. The terminal measures the strength of the RS for the resource configured by the base station and implicitly reports RSRP information for the best four beams (RI) to the base station. The method for reporting the measurement results also follows the base station's RRC configuration, and 3GPP specifies that the configuration is performed by one of the following three methods.
periodic reporting
aperiodic reporting
semi persistent reporting

FIG. 11A illustrates a periodic CSI reporting scheme, which is triggered through RRC configuration. Specifically, the terminal receives an RRC configuration message from the base station, and the RRC configuration message includes configuration information for CSI-related RS resources and the reporting method, i.e., CSI resource set information and information that the CSI report is periodic (S1101a). Based on the received RRC configuration message, the terminal then receives RSs that are transmitted periodically (S1102a and S1105a) and measures the signal strength of the beams based on the received RSs (S1103a and S1106a). Then, the terminal periodically reports the measured result (value) to the base station (S1104a and S1107a).

FIG. 11B illustrates an aperiodic CSI reporting scheme, in which even when CSI-related RS resources and reporting methods are configured via an RRC configuration message, beam measurements based on RS are not performed without a trigger message (or information) from a lower layer. Specifically, the terminal receives an RRC configuration message from the base station, that includes configuration information for CSI-related RS resources and reporting methods, i.e., CSI resource set information and information that the CSI report is aperiodic (S1101b). A CSI report trigger is then provided through a medium access control (MAC) control element (CE) or downlink control information (DCI). The terminal receives CSI report trigger information from the base setation where a trigger indication is included via MAC CE or DCI (S1102b). The terminal receives RSs that are transmitted once based on the received trigger indication (S1103b). The RS transmission for the CSI resource set may occur after a specific time (e.g., X slots) following the transmission of the CSI report trigger information. The terminal measures the signal strength for the beams based on the received RSs (S1104b). Then, the terminal reports the measured result (value) once to the base station (S1105b). The CSI report may also be transmitted after a specific time (e.g., Y slots) following receipt of the CSI report trigger information.

FIG. 11C illustrates a semi-persistent reporting scheme, which operates as an intermediate method between periodic and aperiodic reporting. In this scheme, a terminal that receives configuration for CSI-related RS resources and reporting methods via an RRC configuration message performs periodic CSI reporting only when activated by a MAC CE and continues such reporting until a deactivation message (or, information) is received. Specifically, the terminal receives an RRC configuration message from the base station, that includes configuration information for CSI-related RS resources and reporting methods, i.e., CSI resource set information and information indicating that the CSI report is semi-persistent (S1101c), and CSI report activation is provided through a MAC CE. The terminal receives CSI report activation information including an activation indication from the base station via MAC CE (S1102c and S1110c), receives periodically transmitted RSs based on the received activation indication (S1103c, S1106c, S1111c), and S1114c, and measures the signal strength for the beams based on the received RSs (S1104c, S1107c, S1112c, and S1115c). Then, the terminal periodically reports the measured result (value) to the base station (S1105c, S1108c, S1113c, and S1116c). After CSI reporting is activated, when CSI report deactivation information including a deactivation indication is received from the base station via MAC CE (S1109c), the terminal stops CSI reporting.

Table 5 below shows the CSI-ResourceConfig defined in 3GPP standard TS 38.331.

```
TABLE 5
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

| | |
|---|---|
| nzp-CSI-RS-ResourceSetList | SEQUENCE (SIZE (1..maxNrofNZP-CSI- |

RS-ResourceSetsPerConfig)) OF NZP-CSI-RS-ResourceSetId

O P

TIONAL, -- Need R

| | |
|---|---|
| csi-SSB-ResourceSetList | SEQUENCE (SIZE (1..maxNrofCSI-SSB-Re |

sourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-Resourc |

eSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

```
    ...,
    [[
```

| | |
|---|---|
| csi-SSB-ResourceSetListExt-r17 | CSI-SSB-ResourceSetId |

```
          OPTIONAL -- Need R
    ]]
  }
  -- TAG-CSI-RESOURCECONFIG-STOP
  -- ASN1STOP
```

In NR, depending on whether the number of reported resource groups per CSI-report (nrofReportedGroups-r17) is configured within the CSI-ReportConfig defined in 3GPP TS 38.331, only one or two CSI-RS resource may to be configured using a single CSI-RS resource configuration as shown in Table 5 when the resource type is periodic or semi-persistent. This supports group-based beam reporting for two resource sets. Recently, 3GPP has been considering the application of an AI/ML model to improve beam search/measurement delay and terminal power consumption, and has initiated a study to discuss the feasibility and potential specification impact of this approach.

A list of terminologies applied to AI/ML is being discussed as shown in Table 6 below.

TABLE 6

| Terminology | Description |
|---|---|
| Data collection | A process of collecting data by the network nodes, |
| | management entity, or UE for the purpose of AI/ML model |
| | training, data analytics and inference |
| AI/ML Model | A data driven algorithm that applies AI/ML techniques to |
| | generate a set of outputs based on a set of inputs. |
| AI/ML model training | A process to train an AI/ML Model [by learning the input/ |
| | output relationship] in a data driven manner and obtain |
| | the trained AI/ML Model for inference |
| AI/ML model Inference | A process of using a trained AI/ML model to produce a set |
| | of outputs based on a set of inputs |
| AI/ML model validation | A subprocess of training, to evaluate the quality of |
| | an AI/ML model using a dataset different from one used |
| | for model training, that helps selecting model parameters |
| | that generalize beyond the dataset used for model training. |
| AI/ML model testing | A subprocess of training, to evaluate the performance of a |
| | final AI/ML model using a dataset different from one used |
| | for model training and validation. Differently from AI/ML |
| | model validation, testing does not assume subsequent |
| | tuning of the model. |
| UE-side (AI/ML) model | An AI/ML Model whose inference is performed entirely |
| | at the UE |
| Network-side (AI/ML) | An AI/ML Model whose inference is performed entirely |
| model | at the network |
| One-sided (AI/ML) | A UE-side (AI/ML) model or a Network-side (AI/ML) model |
| model | |
| Two-sided (AI/ML) | A paired AI/ML Model(s) over which joint inference is |
| model | performed, where joint inference comprises AI/ML Inference |
| | whose inference is performed jointly across the UE and |
| | the network, i.e, the first part of inference is firstly |
| | performed by UE and then the remaining part is performed |
| | by gNB, or vice versa. |
| AI/ML model transfer | Delivery of an AI/ML model over the air interface, either |
| | parameters of a model structure known at the receiving end |
| | or a new model with parameters. Delivery may contain a |
| | full model or a partial model. |
| Model download | Model transfer from the network to UE |
| Model upload | Model transfer from UE to the network |
| Federated learning/ | A machine learning technique that trains an AI/ML model |
| federated training | across multiple decentralized edge nodes (e.g., UEs, gNBs) |
| | each performing local model training using local data |
| | samples. The technique requires multiple interactions of |
| | the model, but no exchange of local data samples. |
| Offline field data | The data collected from field and used for offline training |
| | of the AI/ML model |
| Online field data | The data collected from field and used for online training |
| | of the AI/ML model |
| Model monitoring | A procedure that monitors the inference performance of |
| | the AI/ML model |
| Supervised learning | A process of training a model from input and its |
| | corresponding labels. |
| Unsupervised learning | A process of training a model without labelled data. |
| Semi-supervised | A process of training a model with a mix of labelled data |
| learning | and unlabelled data |
| Reinforcement Learning | A process of training an AI/ML model from input (a.k.a. |
| (RL) | state) and a feedback signal (a.k.a. reward) resulting from |
| | the model's output (a.k.a. action) in an environment the |
| | model is interacting with. |
| Model activation | enable an AI/ML model for a specific function |
| Model deactivation | disable an AI/ML model for a specific function |
| Model switching | Deactivating a currently active AI/ML model and activating |
| | a different AI/ML model for a specific function |

3GPP has decided to conduct a study on the specification impact for “Indication of the associated Set A from network to UE” in relation to a UE-side AI/ML model for BM-Case1 (spatial beam prediction) and BM-Case2 (temporal beam prediction) within the beam management procedure.

Meanwhile, the typical beam management operations in NR results in increased system overhead and increased power consumption at the terminal as the number of beams and the number of terminals increases. In addition, for a terminal in the initial cell access stage, a delay in cell access may occur because the terminal must measure all beams before selecting an initial beam. To improve this problem, the use of an AI/ML model that predicts the strength of all beams based on measurement of only a subset of beams is being proposed, but detailed procedures or methods for such an approach have not yet been defined. This specification proposes a scheme for efficiently collecting beam information from a terminal when a network performs model monitoring for related functions, as part of effective beam management operations.

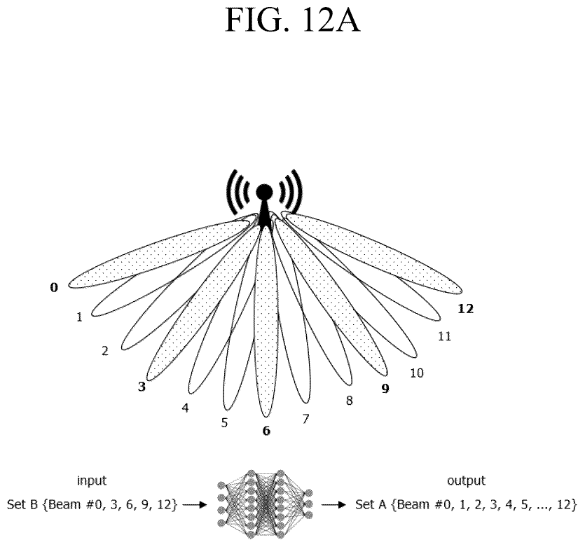

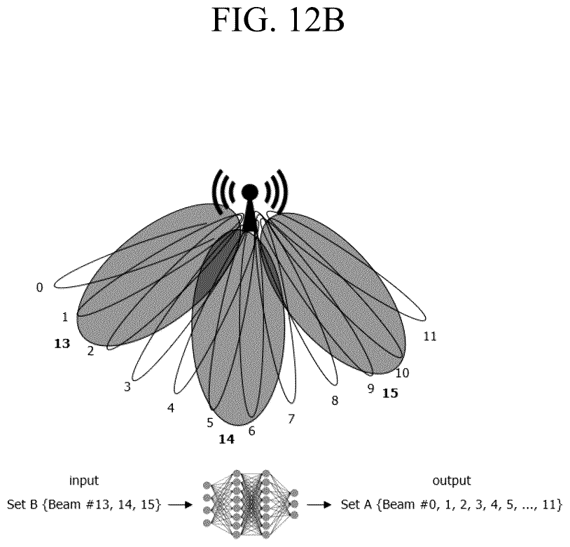

FIGS. 12A and 12B illustrate an example of beam measurement and spatial domain beam prediction using AI/ML.

Currently, 3GPP RAN (radio access network) WG1 (working group 1) has initiated a study on ‘AI/ML for beam management’ and has agreed to discuss spatial DL beam prediction (BM-Case1) and temporal DL beam prediction (BM-Case2) as sub-use cases. This study enables predicting the strength of a beam for Set A based on measurements of beams belonging to Set B. The case of spatial DL beam prediction is illustrated in FIGS. 12A and 12B, where FIG. 12A illustrates the case in which Set B is a subset of Set A, and FIG. 12B illustrates the case in which Set B is composed of a wide beam and Set A is composed of a narrow beam, i.e., the two sets are composed of different beams. In the case of temporal DL beam prediction, in addition to i) the case where Set B is a subset of Set A and ii) the case where Set A and Set B are different sets for spatial DL beam prediction, iii) the case where Set A and Set B are composed of the same set is also considered. Temporal DL beam prediction involves predicting future beam information based on past beam measurement information, and a method of applying this to iii) the case where Set A and Set B are composed of the same set after predicting the entire beam based on spatial DL beam prediction could be considered. For these reasons, i) the case where Set B is a subset of Set A and ii) the case where Set A and Set B are different sets for spatial DL beam prediction are expected to serve as basic beam prediction methods.

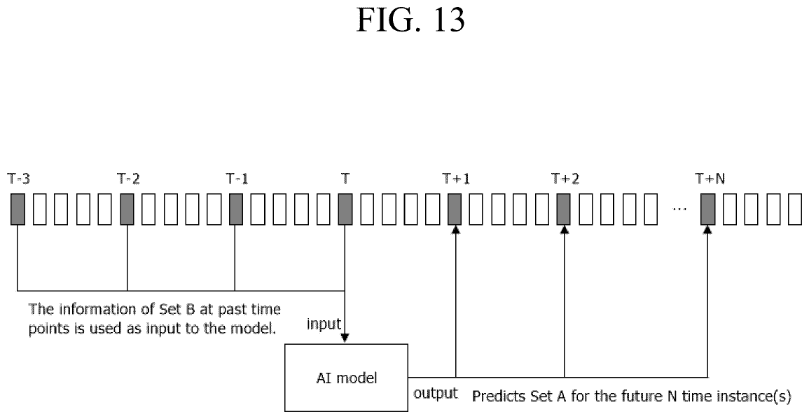

FIG. 13 illustrates an example of temporal domain beam prediction using AI/ML.

The temporal domain beam prediction of BM-Case2, as shown in FIG. 13, is defined as an operation of predicting a beam result at a specific point in the near future (i.e., output) based on past beam measurement information (i.e., input). At this time, the beam set used as input and the beam set derived as output may consider the following cases, as previously explained, i) the case where Set B is a subset of Set A, ii) the case where Set A and Set B are different sets, and additionally, iii) the case where Set A and Set B are composed of the same set.

Meanwhile, in NR, a terminal measures the beam strength using a CSI-RS resource for a beam configured by a base station and reports a maximum of four “CRI (CSI-RS resource indicator)/SSBID+RSRP” for the beam(s) with the highest reference signal received power (RSRP) to the base station. However, when inferring the RSRP of a beam for Set A based on a beam measurement for Set B using AI/ML, the following problems may arise depending on the node performing the inference.
UE-side AI/ML model: When the UE performs model inference

In this case, the terminal measures the beam (Set B) to be used as an input value and must also know the information of the beam belonging to Set A for beam inference. According to the current CSI-RS resource configuration in NR, all CSI-RSs for the beam configured by the base station are transmitted, and the terminal measures the signal strength of all transmitted CSI-RSs. When the base station configures a CSI-RS resource set composed of beams for Set B for the terminal, there is no mechanism for the terminal to obtain information about Set A using the current NR beam management technique.
Network-side AI/ML model (NW-side AI/ML model): When the NW performs model inference

In this case, a CSI-RS resource set composed of CSI-RS resources for Set B is configured for the terminal, but there is no way for the terminal to determine whether to transmit only the maximum of four “CRI/SSBID+RSRP” with the highest RSRP as in the conventional method, or whether to transmit the results for Set B (e.g., all or some (more than four)) used for inference on the NW side.

Based on the foregoing, this specification proposes an efficient beam configuration and reporting scheme for effective model inference when performing beam management using an AI/ML model.

Furthermore, to enable a terminal and a base station to efficiently perform AI/ML model inference for beam management, an embodiment of this specification configures at least two CSI resource sets having an association within a single CSI resource configuration, and a first CSI-RS resource set composed of reference signals for actual transmission (i.e., beams that the terminal must measure for model inference, Set B) and a second CSI-RS resource set composed of a virtual reference signal that can be inferred by an AI/ML model (i.e., a beam that can be predicted by the terminal through model inference, Set A) are defined. And, based on the aforementioned configuration, a beam measurement and reporting procedure for a terminal is proposed.

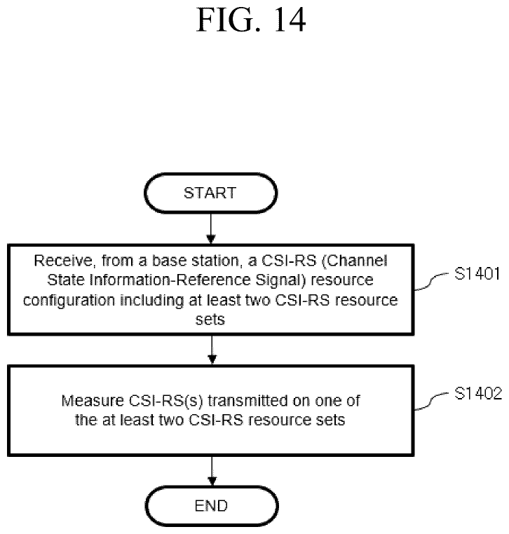

FIG. 14 illustrates an operation method of a terminal according to an embodiment of the disclosure.

Referring to FIG. 14, the terminal receives a CSI-RS resource configuration including at least two CSI (channel state information)-RS (reference signal) resource sets from a base station (S1401). Here, it is preferable that the CSI-RS resource sets are NZP (non-zero power) resource sets.

Thereafter, based on the received CSI-RS resource configuration, the terminal measures CSI-RS(s) transmitted in one CSI-RS resource set among the at least two CSI-RS resource sets (S1402).

A CSI resource configuration including at least two CSI-RS resource sets needs to indicate that the at least two CSI-RS resource sets have an association relationship with each other. This may be indicated by including an indicator (e.g., enable/disable) that informs the purpose of the reference signal resource configuration in the CSI resource configuration, or it may be implicitly defined so that the terminal can recognize that the included CSI-RS sets have an association relationship when the resource type is periodic/semi-persistent and group based beam reporting is disabled but at least two CSI-RS resource sets are included. Alternatively, the association between them may be indicated by mapping the CSI-RS resource set identity (ID) for actual transmission (Set B) that has an association relationship with the set in the configuration information element (IE) of the virtual (Set A) CSI-RS resource set(s). Conversely, a method may also be applied that maps the associated at least one CSI-RS resource set ID(s) from the CSI-RS resource set that transmits the actual reference signal.

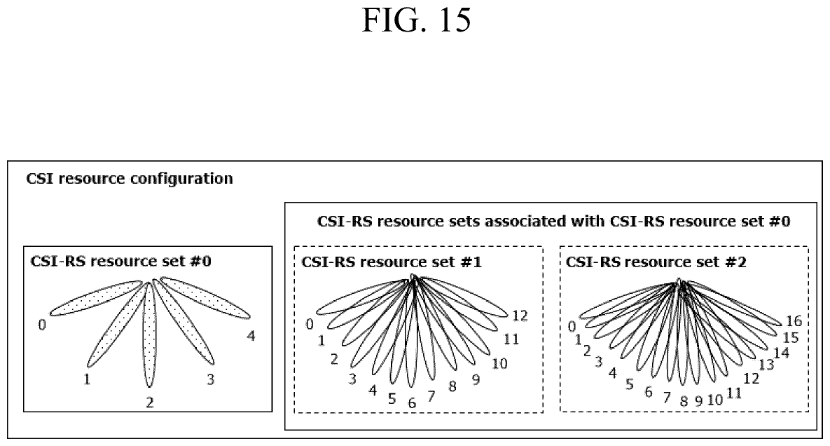

FIG. 15 is an example illustrating the association between CSI resource sets according to an embodiment of the disclosure.

Among the at least two CSI-RS resource sets having an association relationship as described above, only the CSI-RS resource(s) belonging to one set may be used for actual transmission (i.e., measurement by the terminal). When two or more CSI-RS resource sets with an association relationship are configured, it means that the remaining set(s) other than the CSI-RS resource set where the actual reference signal is transmitted are all CSI-RS resource set(s) for configuring at least one virtual beam configuration that can be used for inference (i.e., at least one Set A associated with one Set B). For example, when there is one or more models that infer a different number of beams for Set B, one or more virtual CSI-RS resource sets for at least one Set A may be configured to support this.

FIG. 15 is an example showing the association between the aforementioned CSI resource sets, where CSI-RS resource set #0 represents the CSI-RS resource set where the actual reference signal is transmitted, and CSI-RS resource set #1 and CSI-RS resource set #2 represent the CSI-RS resource sets for configuring a virtual beam configuration (i.e., at least one Set A associated with one Set B) in association with CSI-RS resource set #0.

Furthermore, the following two methods are proposed as a way to distinguish the set where the reference signal is actually transmitted among the two or more CSI-RS resource sets that have an association with each other as described above.

### Method 1: Implicit Indication

When two or more associated CSI resource sets are included within a single CSI resource configuration, the CSI-RS(s) belonging to the CSI-RS resource set with the lowest CSI-RS resource set identity (ID) (e.g., “0”) is configured as the beam (Set B) on which reference signals are actually transmitted from the base station. The CSI-RS(s) belonging to the CSI-RS resource set(s) other than the CSI-RS resource set with the lowest CSI-RS resource set ID are not transmitted from the base station but are configured as a beam (Set A) that can be inferred by an AI/ML model. The terminal may measure only the signal strength for the CSI-RS(s) transmitted from the CSI-RS resource set with the lowest CSI-RS resource set ID.

### Method 2: Explicit Indication

When two or more associated CSI resource sets are included within a single CSI resource configuration, an explicit indication is included for each set to inform whether a CSI resource set is a configuration for actual CSI-RS(s) transmission (Set B) or a configuration including virtual CSI-RS(s) to set up a beam to be inferred by an AI/ML model (Set A). A specific method for this is as follows.

Method 2-1: A 1-bit indication that indicates ON/OFF (or enabled/disabled) whether the set is a configuration for transmitting an actual reference signal or not may be included within each CSI-RS resource set configuration information element (IE).

Method 2-2: An associated CSI-RS resource set ID where an actual reference signal is transmitted that has an association relationship with the set may be included within the virtual CSI-RS resource set(s) configuration IE. When an associated set ID is included, it may be recognized that this is a virtual CSI-RS resource set. That is, it may be recognized that a CSI-RS resource set where the associated CSI-RS resource set ID is omitted is a configuration for transmitting an actual reference signal (Set B). This is also applicable as a method of including associated set ID(s) in the configuration of the set that transmits the actual reference signal.

The terminal, using one of the preceding methods, recognizes one CSI resource set where a reference signal is actually transmitted among two or more associated NZP CSI-RS resource sets included in one received CSI resource configuration, and measures the signal strength for the CSI-RS(s) transmitted in the corresponding CSI resource set. The remaining CSI resource set(s) are utilized to acquire beam index (e.g., CRI) information to be used as an input value for the AI/ML model, and beam measurement for the corresponding set is not performed.

In this specification, a CSI-RS resource set where an actual reference signal is transmitted may be named a CSI-RS resource set for Set B, and a CSI-RS resource set that configures a virtual reference signal may be called a CSI-RS resource set for Set A.

Meanwhile, a terminal that has measured the signal strength of a beam belonging to Set B according to the configuration scheme proposed in this specification may perform different reporting schemes depending on the location of the model inference node.

First, when the terminal performs model inference, the terminal uses the signal strength result of the measured beam as an input value for the model to infer Set A. To this end, the terminal needs to know the mapping relationship between each actually measured beam and the beams to be inferred. This may be defined differently depending on the relationship between Set A and Set B, that is, whether i) Set B is a subset of Set A, or ii) Set B and Set A are composed of different beams.

The foregoing will be described in detail below.

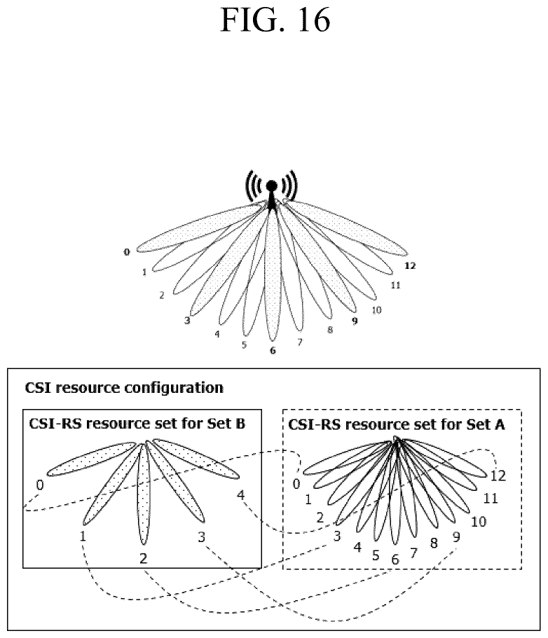

FIG. 16 illustrates an example of beam mapping for two associated CSI-RS resource sets according to an embodiment of the disclosure.

i) In a case where Set B is composed of a subset of Set A, the base station explicitly indicates the beam of Set B to the terminal in the CSI-RS resource set configuration for Set A. That is, for a CSI-RS resource mapped to the same beam as Set B among the CSI-RS resource sets for Set A, the same beam between the two sets is mapped by indicating the CSI-RS resource ID of Set B. Through this, the terminal converts the CRI (CSI-RS Resource Indicator) configured for Set B into the CRI for Set A and uses the “converted CRI+measured RSRP” as the input value for model inference. Furthermore, the “CRI+predicted RSRP” for Set A derived by inference is used for reporting to the base station. FIG. 16 is an example showing the mapping relationship between CSI-RS resources belonging to two associated CSI-RS resource sets in a case where Set B is a subset of Set A.

ii) In a case where Set B is composed of a different beam from Set A, the base station may not include any mapping information. If two or more associated CSI-RS resource sets include a different number of CSI-RS resources, and there is no mapped CSI-RS resource ID, it is recognized that these sets are composed of different beams, and the terminal uses Set B as an input value for model inference and uses the inferred beam result value for Set A for reporting to the base station.

Furthermore, when the base station performs model inference, the terminal must report all or some of the measurement results for Set B to the base station. According to the configuration proposed in this specification, a terminal that has been configured with two or more associated CSI-RS resource sets within a single CSI resource configuration recognizes that it must report all or some of the measurement results for Set B to the base station, and reports the result value for the measured Set B to the base station according to the configuration of the base station. At this time, if Set B is a subset of Set A, the terminal may report the measurement result for Set B using the CRI mapped for Set A.

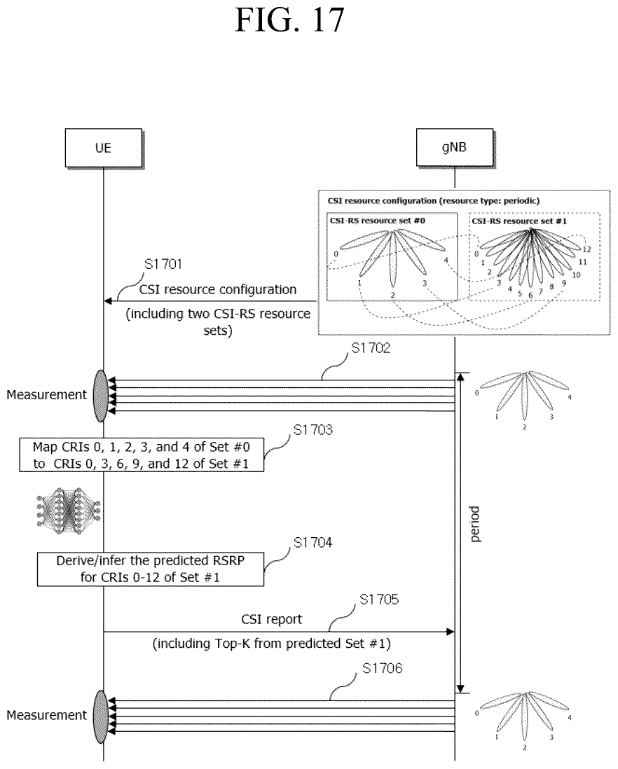

FIG. 17 illustrates a procedure between a terminal and a base station according to an embodiment of the disclosure.

FIG. 17 illustrates a procedure of the terminal and the base station when the terminal performs model inference.

Hereinafter, the operation of the terminal will be described in detail with reference to FIG. 17.

The terminal receives a CSI resource configuration message including two CSI-RS resource sets having an association relationship with each other from the base station (S1701). The CSI resource configuration message may include the following information.
CSI-RS resource set #0: A configuration for actual reference signal transmission, which may include information on 5 NZP CSI-RS resources having IDs of 0 to 4.
CSI-RS resource set #1: A configuration for virtual/inference, which may include information on 13 NZP CSI-RS resources having IDs of 0 to 12. And, for Resource IDs #0, 3, 6, 9, 12, the Resource IDs #0, 1, 2, 3, 4 of the mapped Set #0 may be included within each NZP CSI-RS resource configuration.
Resource transmission type (configured as periodic)
A CSI report configuration mapped to the corresponding CSI resource configuration exists

The terminal, by receiving the CSI resource configuration message, knows that CSI-RS resource set #0 and CSI-RS resource set #1 have an association relationship with each other for model inference, and periodically measures the signal strength for the beam transmitted with the CSI-RS resources configured in CSI-RS resource set #0 (S1702, S1706). That is, the terminal measures the RSRPs for CRIs #0, 1, 2, 3, 4.

The terminal converts (maps) the signal strength for the measured CSI-RSs of CSI-RS resource set #0 to the ID of CSI-RS resource set #1 according to the mapping information of CSI-RS resource set #1 (S1703). That is, the terminal newly maps them to the RSRPs for CRIs #0, 3, 6, 9, 12.

The 5 newly mapped “CRI+measured RSRP” combinations are input as input values for the beam management model. Then, the terminal derives (infers) 13 predicted RSRPs for CRIs #0-12 by the AI/ML model (S1704). Thereafter, the terminal selects top-K beam(s) among them and reports them to the base station (S1705).

Hereinafter, the operation of the base station will be described in detail with reference to FIG. 17.

The base station transmits a CSI resource configuration message including two CSI-RS resource sets having an association relationship with each other to the terminal (S1701). The CSI resource configuration message may include the following information.
CSI-RS resource set #0: A configuration for actual reference signal transmission, which may include information on 5 NZP CSI-RS resources having IDs of 0 to 4.
CSI-RS resource set #1: A configuration for virtual/inference, which may include information on 13 NZP CSI-RS resources having IDs of 0 to 12. And, for Resource IDs #0, 3, 6, 9, 12, the Resource IDs #0, 1, 2, 3, 4 of the mapped Set #0 may be included within each NZP CSI-RS resource configuration.
Resource transmission type (configured as periodic)
A CSI report configuration mapped to the corresponding CSI resource configuration exists

The base station periodically transmits the CSI-RSs configured in CSI-RS resource set #0 based on the CSI resource configuration message (S1702, S1706). That is, they correspond to CRIs #0, 1, 2, 3, 4.

The base station receives a report for the top-K beam(s) derived by model inference from the terminal (S1705). Thereafter, the base station recognizes the CRI for the received top-K as a CSI-RS resource ID mapped in CSI-RS resource set #1, and configures the beam of the terminal based on this.

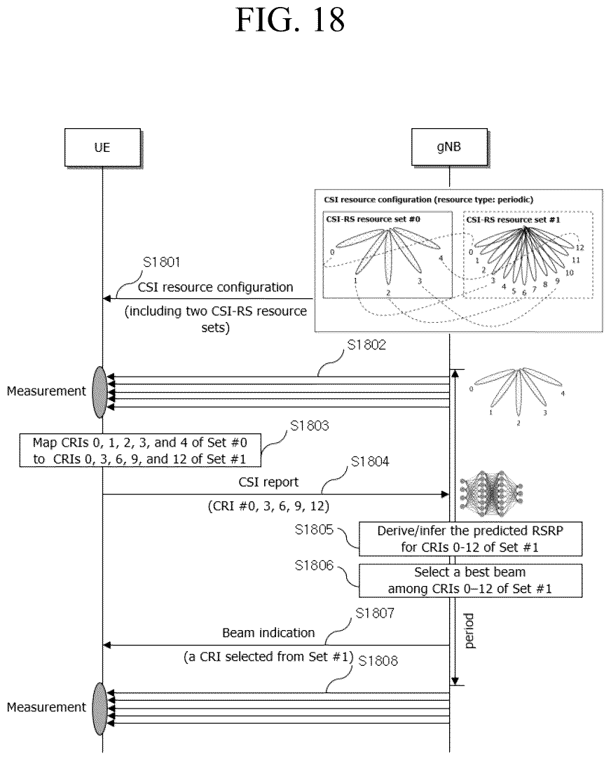

FIG. 18 illustrates a procedure between a terminal and a base station according to another embodiment of the disclosure.

FIG. 18 illustrates a procedure of the terminal and the base station when the base station performs model inference.

Hereinafter, the operation of the terminal will be described in detail with reference to FIG. 18.

The terminal receives a CSI resource configuration message including two CSI-RS resource sets having an association relationship with each other from the base station (S1801). The CSI resource configuration message may include the following information.
CSI-RS resource set #0: A configuration for actual reference signal transmission, which may include information on 5 NZP CSI-RS resources having IDs of 0 to 4.
CSI-RS resource set #1: A configuration for virtual/inference, which may include information on 13 NZP CSI-RS resources having IDs of 0 to 12. And, for Resource IDs #0, 3, 6, 9, 12, the Resource IDs #0, 1, 2, 3, 4 of the mapped Set #0 may be included within each NZP CSI-RS resource configuration.
Resource transmission type (configured as periodic)
A CSI report configuration mapped to the corresponding CSI resource configuration exists

The terminal, by receiving the CSI resource configuration message, knows that CSI-RS resource set #0 and CSI-RS resource set #1 have an association relationship with each other for model inference, and periodically measures the signal strength for the beam transmitted with the CSI-RS resources configured in CSI-RS resource set #0 (S1802, S1808). That is, the terminal measures the RSRPs for CRIs #0, 1, 2, 3, 4.

The terminal converts (maps) the signal strength for the measured CSI-RSs of CSI-RS resource set #0 to the ID of CSI-RS resource set #1 according to the mapping information in CSI-RS resource set #1 (S1803). That is, the terminal newly maps them to the RSRPs for CRIs #0, 3, 6, 9, 12.

The 5 newly mapped “CRI+measured RSRP” combinations are reported to the base station (S1804).

Hereinafter, the operation of the base station will be described in detail with reference to FIG. 18.

The base station transmits a CSI resource configuration message including two CSI-RS resource sets having an association relationship with each other to the terminal (S1801). The CSI resource configuration message may include the following information.
CSI-RS resource set #0: A configuration for actual reference signal transmission, which may include information on 5 NZP CSI-RS resources having IDs of 0 to 4.
CSI-RS resource set #1: A configuration for virtual/inference, which may include information on 13 NZP CSI-RS resources having IDs of 0 to 12. And, for Resource IDs #0, 3, 6, 9, 12, the Resource IDs #0, 1, 2, 3, 4 of the mapped Set #0 may be included within each NZP CSI-RS resource configuration.
Resource transmission type (configured as periodic)
A CSI report configuration mapped to the corresponding CSI resource configuration exists

The base station periodically transmits the CSI-RSs configured in CSI-RS resource set #0 based on the CSI resource configuration message (S1802, S1808). That is, they correspond to CRIs #0, 1, 2, 3, 4.

Subsequently, the base station receives a report of 5 “CRI+measured RSRP” combinations mapped to the CRI for CSI-RS resource set #1 from the terminal (S1804).

The base station inputs the 5 received “CRI+measured RSRP” combinations as input values for the beam management model. Then, the base station derives (infers) 13 predicted RSRPs for CRIs #0-12 of Set #1 by the AI/ML model (S1805). Thereafter, the base station selects one of these beams (S1806) and transmits a beam indication indicating the CRI for the selected beam to the terminal (S1807). At this time, the indicated CRI is an indicator mapped to the CSI-RS resource ID configured in Set #1.

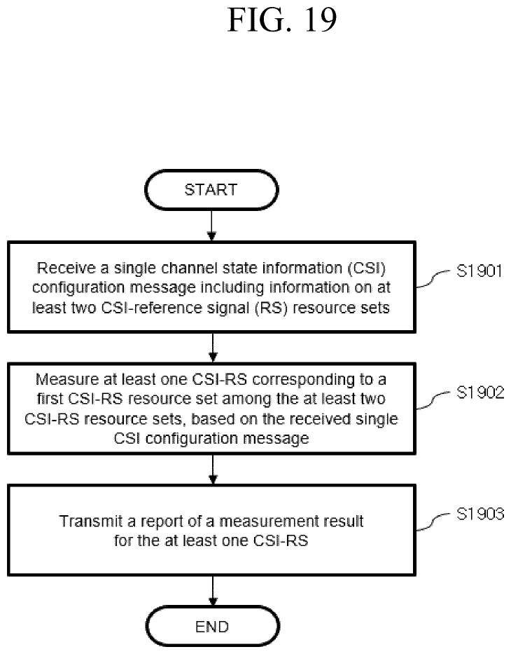

FIG. 19 illustrates an operation method of a terminal according to another embodiment of the disclosure.

Referring to FIG. 19, the terminal receives a single channel state information (CSI) configuration message including information on at least two CSI-reference signal (RS) resource sets from a base station (S1901). Preferably, the CSI-RS resource sets are non-zero power (NZP) resource sets. Subsequently, based on the received single CSI configuration message, the terminal measures at least one CSI-RS corresponding to a first CSI-RS resource set among the at least two CSI-RS resource sets (S1902). In addition, the terminal transmits a report of a measurement result for the at least one CSI-RS (S1903), wherein the report of the measurement result for the at least one CSI-RS may be based on an identity (ID) of a second CSI-RS resource set among the at least two CSI-RS resource sets.

The first CSI-RS resource set may be a subset of the second CSI-RS resource set, and the identifier may be a CSI resource indicator (CRI).

Meanwhile, the measurement result for the at least one CSI-RS may be based on the strength of the at least one CSI-RS.

Based on the identity, the second CSI-RS resource set may be used for prediction that is inferred by an AI/ML (artificial intelligence/machine learning) model.

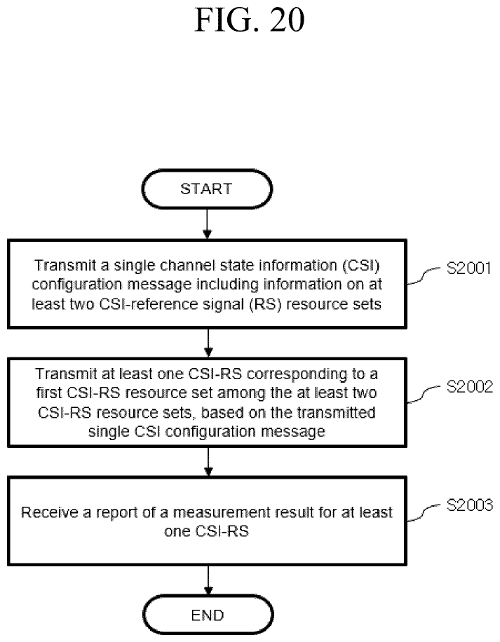

FIG. 20 illustrates an operation method of a base station according to an embodiment of the disclosure.

Referring to FIG. 20, the base station transmits a single channel state information (CSI) configuration message including information on at least two CSI-reference signal (RS) resource sets to a terminal (S2001). Preferably, the CSI-RS resource sets are non-zero power (NZP) resource sets. Subsequently, based on the transmitted single CSI configuration message, the base station transmits at least one CSI-RS corresponding to a first CSI-RS resource set among the at least two CSI-RS resource sets (S2002). In addition, the base station receives a report of a measurement result for the at least one CSI-RS (S2003), wherein the report of the measurement result for the at least one CSI-RS may be based on an identity (ID) in a second CSI-RS resource set among the at least two CSI-RS resource sets.

The first CSI-RS resource set may be a subset of the second CSI-RS resource set, and the identity may be a CSI resource indicator (CRI).

Meanwhile, the measurement result for the at least one CSI-RS may be based on the strength of the at least one CSI-RS.

Based on the identity, the second CSI-RS resource set may be used for prediction inferred by an AI/ML (artificial intelligence/machine learning) model.

The disclosures in this specification may be applied independently or may be operated in any combination of forms. Furthermore, although this specification is described based on a 5G NR system, it may be included in the scope of this specification for all cases where the concept of this specification is applied, regardless of the specific wireless communication technology.

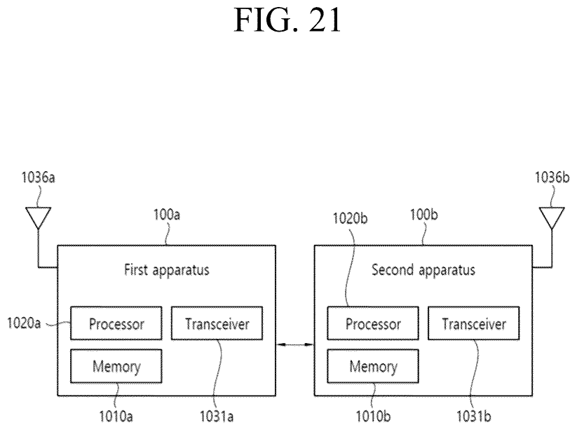

FIG. 21 shows apparatuses according to an embodiment of the disclosure.

Referring to FIG. 21, a wireless communication system may include a first apparatus 100a and a second apparatus 100b.

The first apparatus 100a may include a base station, a network node, a transmission user equipment (UE), a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IOT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IOT) apparatus, a medial apparatus, a finance technology (Fin Tech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may perform the foregoing functions, procedures, and/or methods. The processor 1020a may implement one or more protocols. For example, the processor 1020a may perform one or more layers of a radio interface protocol. The memory 1010a may be connected to the processor 1020a and configured to various types of information and/or instructions. The transceiver 1031a may be connected to the processor 1020a, and controlled to transceive a radio signal.

The second apparatus 100b may include at least one processor such as a processor 1020b, at least one memory device such as a memory 1010b, and at least one transceiver such as a transceiver 1031b. The processor 1020b may perform the foregoing functions, procedures, and/or methods. The processor 1020b may implement one or more protocols. For example, the processor 1020b may implement one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b, and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

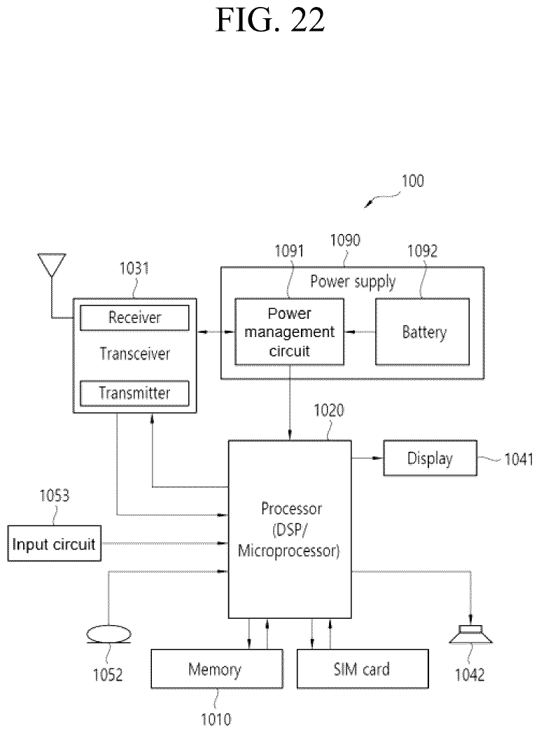

FIG. 22 is a block diagram showing a configuration of a terminal according to an embodiment of the disclosure.

In particular, FIG. 22 illustrates the foregoing apparatus of FIG. 21 in more detail.

The apparatus includes a memory 1010, a processor 1020, a transceiver 1031, a power management circuit 1091, a battery 1092, a display 1041, an input circuit 1053, a loudspeaker 1042, a microphone 1052, a subscriber identification module (SIM) card, and one or more antennas.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management circuit 1091 manages a power for the processor 1020 and/or the transceiver 1031. The battery 1092 supplies power to the power management module 1091. The display 1041 outputs the result processed by the processor 1020. The input circuit 1053 receives an input to be used by the processor 1020. The input unit 1053 may be displayed on the display 1041. The SIM card is an integrated circuit used to safely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

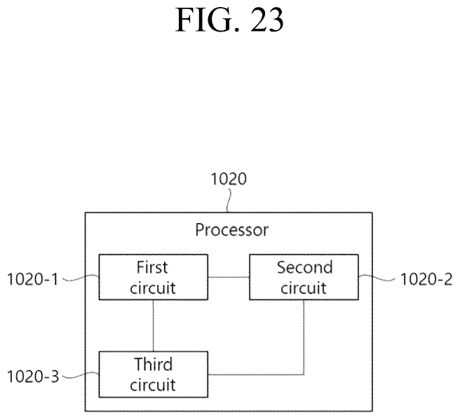

FIG. 23 is a configuration block diagram of a processor in which the disclosure is implemented.

Referring to FIG. 23, a processor 1020 may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP). The processor 1020 may include at least one of a digital signal processor (DSP), a central processing unit (CPU), and a graphics processing unit (GPU).

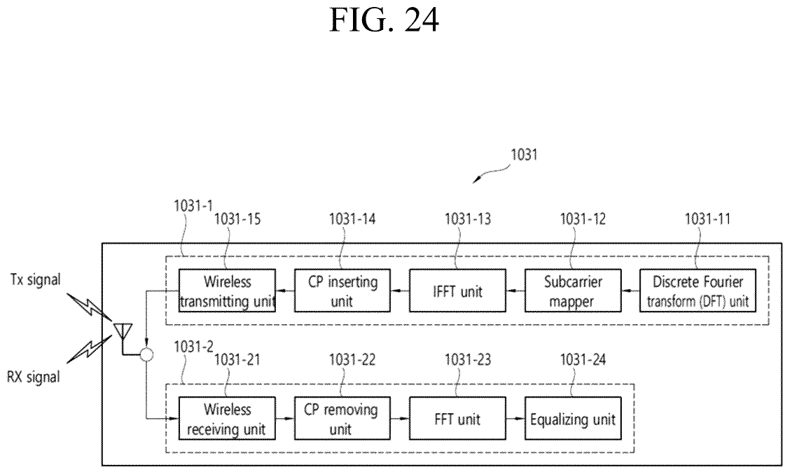

FIG. 24 is a detailed block diagram of a transceiver of a first apparatus shown in FIG. 21 or a transceiving unit of an apparatus shown in FIG. 22.

Referring to FIG. 24, the transceiving unit 1031 includes a transmitter 1031-1 and a receiver 1031-2. The transmitter 1031-1 includes a discrete Fourier transform (DFT) unit 1031-11, a subcarrier mapper 1031-12, an IFFT unit 1031-13, a cyclic prefix (CP) insertion unit 1031-14, and a wireless transmitting unit 1031-15. The transmitter 1031-1 may further include a modulator. Further, the transmitter 1031-1 may for example include a scramble unit (not shown), a modulation mapper (not shown), a layer mapper (not shown), and a layer permutator (not shown), which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some of constituent elements is referred to as a unit in the disclosure. However, the embodiments are not limited thereto. For example, such term “unit” is also referred to as a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21, a CP removing unit 1031-22, an FFT unit 1031-23, and an equalizing unit 1031-24. The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

1. A method of a terminal to operate in a wireless communication system, the method comprising:
receiving a single channel state information (CSI) configuration message including information on at least two CSI-reference signal (RS) resource sets;
measuring at least one CSI-RS corresponding to a first CSI-RS resource set among the at least two CSI-RS resource sets, based on the received single CSI configuration message; and
transmitting a report of a measurement result for the at least one CSI-RS,
wherein the report of the measurement result for the at least one CSI-RS is based on an identity (ID) of a second CSI-RS resource set among the at least two CSI-RS resource sets.

2. The method of claim 1, wherein the first CSI-RS resource set is a subset of the second CSI-RS resource set.

3. The method of claim 1, wherein the identity is a CSI resource indicator (CRI).

4. The method of claim 1, wherein the measurement result for the at least one CSI-RS is based on a strength of the at least one CSI-RS.

5. The method of claim 1, wherein the at least two CSI-RS resource sets are at least two non-zero power (NZP) CSI-RS resource sets whose resource type is periodic or semi-persistent.

6. The method of claim 1, wherein, based on the identity, the second CSI-RS resource set is used for prediction that is inferred by an AI/ML (artificial intelligence/machine learning) model.

7. A method of a base station to operate in a wireless communication system, the method comprising:
transmitting a single channel state information (CSI) configuration message including information on at least two CSI-reference signal (RS) resource sets;
transmitting at least one CSI-RS corresponding to a first CSI-RS resource set among the at least two CSI-RS resource sets, based on the transmitted single CSI configuration message; and
receiving a report of a measurement result for the at least one CSI-RS,
wherein the report of the measurement result for the at least one CSI-RS is based on an identity (ID) of a second CSI-RS resource set among the at least two CSI-RS resource sets.

8. The method of claim 7, wherein the first CSI-RS resource set is a subset of the second CSI-RS resource set.

9. The method of claim 7, wherein the identity is a CSI resource indicator (CRI).

10. The method of claim 7, wherein the measurement result for the at least one CSI-RS is based on a strength of the at least one CSI-RS.

11. The method of claim 7, wherein the at least two CSI-RS resource sets are at least two non-zero power (NZP) CSI-RS resource sets whose resource type is periodic or semi-persistent.

12. The method of claim 7, wherein, based on the identity, the second CSI-RS resource set is used for prediction that is inferred by an AI/ML (artificial intelligence/machine learning) model.

13. A communication apparatus in a wireless communication system, the communication apparatus comprising:
at least one processor; and
at least one memory configured to store instructions and be operably electrically connectable to the at least one processor, wherein operations performed based on the instructions executed by the at least one processor comprise:
receiving a single channel state information (CSI) configuration message including information on at least two CSI-reference signal (RS) resource sets;
measuring at least one CSI-RS corresponding to a first CSI-RS resource set among the at least two CSI-RS resource sets, based on the received single CSI configuration message; and
transmitting a report of a measurement result for the at least one CSI-RS,
wherein the report of the measurement result for the at least one CSI-RS is based on an identity (ID) of a second CSI-RS resource set among the at least two CSI-RS resource sets.

14. The communication apparatus of claim 13, wherein the first CSI-RS resource set is a subset of the second CSI-RS resource set.

15. The communication apparatus of claim 13, wherein the identity is a CSI resource indicator (CRI).

16. The communication apparatus of claim 13, wherein the measurement result for the at least one CSI-RS is based on a strength of the at least one CSI-RS.

17. The communication apparatus of claim 13, wherein the at least two CSI-RS resource sets are at least two non-zero power (NZP) CSI-RS resource sets whose resource type is periodic or semi-persistent.

18. The communication apparatus of claim 13, wherein, based on the identity, the second CSI-RS resource set is used for prediction that is inferred by an AI/ML (artificial intelligence/machine learning) model.
